(19) United States
(12) Patent Application Publication
(10) Pub. No.: US 2025/0315580 A1
(43) Pub. Date: Oct. 9, 2025

(54) Method for Constructing Fishbone H-Clock Tree Suitable for High-Speed Interface Module

(71) Applicant: Jiangsu Huachuang Microsystem Company Limited, Nanjing (CN)

(72) Inventors: Zhenkun SONG, Nanjing (CN); Guoqiang HE, Nanjing (CN); Shiping LI, Nanjing (CN); Bing HU, Nanjing (CN); Haibin ZHOU, Nanjing (CN)

(73) Assignee: Jiangsu Huachuang Microsystem Company Limited, Nanjing (CN)

(21) Appl. No.: 19/010,247

(22) Filed: Jan. 6, 2025

(30) Foreign Application Priority Data
Apr. 3, 2024 (CN) 202410401214.3

(51) Int. Cl. G06F 30/31; G06F 30/396

(52) U.S. Cl. CPC G06F 30/31; G06F 30/396

(57) ABSTRACT

A method for constructing a fishbone H-clock tree suitable for a high-speed interface module includes the following steps: S1, setting an instance of a clock tree by means of an EDA tool, and eliminating existing definitions; S2, setting a root node, a non-default routing rule and multiple TAP nodes; S3, creating an H-clock tree, and performing H-clock tree synthesis, wherein the H-clock tree synthesis includes: introducing multiple intermediate nodes between the root node and the TAP nodes, editing a clock network between the root node and the TAP nodes by means of an innovus script, and deleting each redundant intermediate node to obtain a structure of a fishbone H-clock tree; mounting multiple sinks on each TAP node, and defining the TAP nodes in a same source group by means of the EDA tool; and performing routing according to the non-default routing rule to complete construction.

### CROSS REFERENCE TO THE RELATED APPLICATIONS

This application is based upon and claims priority to Chinese Patent Application No. 202410401214.3, filed on Apr. 3, 2024, the entire contents of which are incorporated herein by reference.

### TECHNICAL FIELD

The invention relates to the field of clock tree synthesis in digital backend design of chips, in particular to a method for constructing a fishbone H-clock tree suitable for a high-speed interface module.

### BACKGROUND

Clock trees may have various structures according to their distribution characteristics in chips, including conventional clock trees, H-clock trees, X-clock trees, balanced clock trees and comb or spine clock meshes. The H-clock tree is simple in structure and easy to implement. The distances from the center of the H-clock tree to test access port (TAP) nodes are equal, so the theoretical clock skew of the H-clock tree is 0, and a smaller clock skew is more beneficial to the closure of the hold time. The H-clock tree is suitable for a module where macrocells are distributed in an array.

Based on an electronic design automation (EDA) tool, a traditional H-clock tree can be designed in a module where macrocells are distributed in an array, to satisfy the design requirement for a common low-speed H-clock tree. However, with the continuous development of advanced technology, the performance requirement becomes higher, and existing design of an H-clock tree in the EDA tool has at least the following two problems:
(1) An H-clock tree and a high-speed interface module are incompatible, and an existing H-clock tree cannot satisfy the performance requirement of the high-speed interface module;
(2) The clock latency and skew are large, and timing recovery caused by the clock latency and skew is difficult.

### SUMMARY

In view of the problems (1) and (2), the invention aims to provide a method for constructing a fishbone H-clock tree suitable for a high-speed interface module. According to the method, intermediate nodes are introduced into a clock network and then redundant nodes are eliminated, such that an H-clock tree is compatible with a high-speed interface module, and the clock latency and skew are effectively reduced; and multiple sinks are uniformly mounted on TAP nodes, such that the performance is improved, and loads are balanced.

To settle the above technical issue, the invention provides a method for constructing a fishbone H-clock tree suitable for a high-speed interface module; which is implemented by the following technical solution:

A method for constructing a fishbone H-clock tree suitable for a high-speed interface module, including the following steps:
S1, setting an instance of a clock tree by means of an EDA tool, instantiating a clock gating cell in advance, and eliminating existing definitions in the clock tree;
S2, setting a root node according to the clock gating cell in S1; and setting a non-default routing rule and multiple TAP nodes in the clock tree; and
S3, according to the setting in S1 and the setting in S2, creating an H-clock tree and performing clock tree synthesis by means of the EDA tool, wherein the clock tree synthesis at least includes:

introducing multiple intermediate nodes between the root node and the TAP nodes in S2 to adapt to a high-speed interface node; editing a clock network between the root node and the TAP nodes by means of an innovus script in the EDA tool, and deleting each redundant intermediate node between the root node and the TAP nodes to obtain a structure of a fishbone H-clock tree; mounting multiple sinks on each TAP node, defining a generated clock for each TAP node by means of the EDA tool and defining the TAP nodes in a same source group; and performing routing according to the non-default routing rule in S2 to complete construction of the fishbone H-clock tree.

After existing definitions in the clock tree are eliminated, a new root node, a non-default routing rule and multiple TAP nodes are set, such that an H-clock tree with an optimized structure is constructed, and the structure can be modified easily; after intermediate nodes are introduced, redundant intermediate nodes are eliminated, such that the H-clock tree is compatible with a high-sped interface module, the clock latency and skew are effectively reduced, and the H-clock tree is fishbone-shaped; in addition, the TAP nodes are defined in a same source group, such that the clock skew can be effectively optimized.

Preferably, wherein when the clock gating cell is set in S1, the clock gating cell is set to be in a cloneable state. Considering that the length of a clock tree will be increased if registers in different regions are mounted on a same clock gating cell, the clock gating cell is set to be cloneable, such that the clock gating cell can be duplicated to allow registers in different regions to be mounted in their regions.

Preferably, the clock network between the root node and the TAP nodes is taken as a trunk; and in S2, a method for setting the non-default routing rule includes: setting a routing width and a number of metal layers for the trunk, and setting a shield mechanism in the truck. A shield mechanism is set to effectively eliminate interference, such that the influence of external signals on the clock tree is reduced.

Preferably, wherein after the number of metal layers is set for the truck, a top metal layer and a second top metal layer are crossed. A top layer and a second top layer are crossed, such that the routing latency and clock crosstalk are reduced.

Preferably, in S2, a method for setting multiple TAP nodes includes: eliminating overlapped nodes from the clock network according to a physical layer layout corresponding to the non-default wiring rule; and after the overlapped nodes are eliminated from the clock network, selecting multiple positions in the clock network as positions of the TAP nodes, and the TAP nodes have a same path in the clock network. Overlapped nodes are eliminated, such that invalidity or conflicts of TAP nodes are avoided.

Preferably, the EDA tool includes a clock specification file, the generated clock is defined for each TAP in S3 according to the clock specification file, and numbers of sinks mounted on the TAP nodes are uniformized. Sinks are uniformly mounted on the TAP nodes, such that the clock skew is optimized, and the reliability is improved.

Preferably, the method further including: after the construction of the fishbone H-clock tree is completed, performing simulation verification on the fishbone H-clock tree; if a verification result is acceptable, ending all operations; or, if the verification result is not acceptable, returning to S1 to repeat the operations until the verification result is acceptable. A simulation verification mechanism is set, such that the performance of the fishbone H-clock tree is further guaranteed.

Preferably, the method further including: configuring, in the fishbone H-clock tree, a monitoring module for monitoring the root node and each TAP node, wherein the monitoring module is formed by nondeterministic digital memory cells. The root node and each TAP node are monitored, such that when an error is detected, the position of the error can be determined timely for modification.

Compared with the prior art, the invention has the following beneficial effects:

According to the technical solution of the invention, intermediate nodes are introduced into the clock network and then redundant nodes are eliminated, such that the H-clock tree is compatible with a high-speed interface module, and the clock latency and skew are effectively reduced; in addition, sinks are uniformly mounted on the TAP nodes, such that the performance is improved, and loads are balanced; in addition, metal routing is optimized, and the shield mechanism is set, such that the performance of the H-clock tree is effectively improved.

### BRIEF DESCRIPTION OF THE DRAWINGS

FIG. 1 is a flow diagram of a method for constructing a fishbone H-clock tree suitable for a high-speed interface module.

FIG. 2 is a connection diagram of high-drive buffers before redundant intermediate nodes are deleted.

FIG. 3 is a connection diagram of high-drive buffers after redundant intermediate nodes are deleted.

### DETAILED DESCRIPTION OF THE EMBODIMENTS

The technical solutions in some embodiments of the invention are described in detail below in conjunction with drawings of these embodiments.

### EMBODIMENT

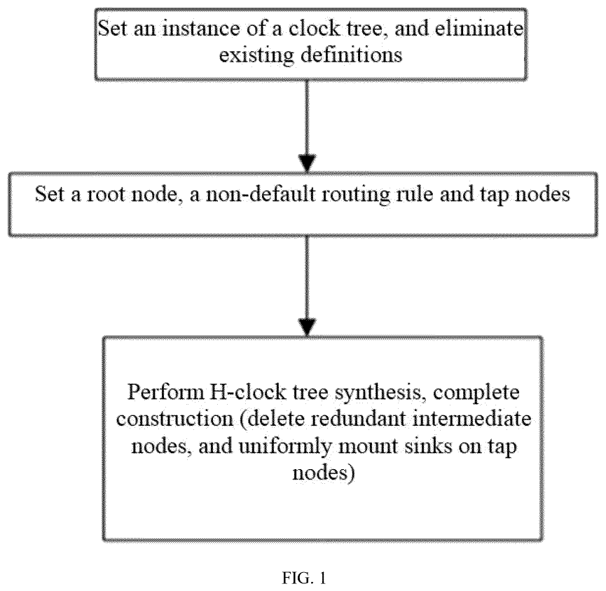

As shown in FIG. 1 which is a flow diagram of a method for constructing a fishbone H-clock tree suitable for a high-speed interface module, the structure of an H-clock tree is optimized, redundant nodes are deleted, and sinks are uniformly mounted on TAP nodes, such that the clock latency and skew are effectively reduced, and the performance of the H-clock tree is improved. In addition, one sink is a CK terminal of a register mounted on a clock tree and is a tail end of the clock tree, and “sinks” is the plural form of sink.

The invention provides a method for constructing a fishbone H-clock tree suitable for a high-speed interface module, wherein the high-speed interface module is strip-shaped and may be horizontal or vertical. The method designs a clock tree in a module formed by macrocells by means of an EDA tool and specifically includes the following steps:

S1, an instance of a clock tree is set by means of the EDA tool and is initialized, existing definitions in the clock tree are eliminated for resetting, and a clock gating cell is configured in the clock tree and is set to be in a cloneable state. Registers in different regions are possibly mounted on a same clock gating cell, and this will increase the length of the clock tree. By setting the clock gating cell to be cloneable, the clock gating cell can be duplicated to allow registers in different registers to be mounted on duplicated clock gating cells in their regions.

It should be noted that the fishbone H-clock tree in this embodiment is a key clock part of a module in actual design. There may be other clock gating cells, buffers and devices behind sinks mounted on the fishbone H-clock tree. This embodiment only describes details of the fishbone H-clock tree and has no limitation to parts behind the sinks, so only one clock gating cell is configured.

S2, a root node, a non-default routing rule and multiple TAP nodes are configured for the clock tree in S1, a clock source, the clock gating cell, a high-drive buffer and multiple TAP nodes are sequentially connected in the clock tree, and the TAP nodes are parallel to each other. The TAP nodes are key nodes in a clock distribution network and used for transmitting a clock signal to functional cells of a chip. The TAP nodes may be buffers or drivers and used for redriving a clock signal to ensure that the clock signal can be stably transmitted to the next node or a final logic cell.

The design and placement of the TAP nodes are of great importance for guaranteeing the timing performance of a whole system, so the TAP nodes should be placed at suitable positions to reduce a skew and jitter that are possibly generated during transmission of a clock signal and should satisfy timing constraints. The skew refers to a difference in the time of arrival of the clock signal to different logic cells, and the jitter refers to the instability of the edge of the clock signal.

In this embodiment, an output terminal of the clock gating cell instantiated in S1 may be selected as an initial position of the root node of the clock tree, and instantiation refers to the creation of an instance. By selecting the initial position, the design of the clock tree can be optimized by means of the clock gating cell instantiated in advance to reduce the transmission latency of a clock signal, improve the performance of a clock network, better control the transmission path of the clock signal, and reduce the clock skew and jitter.

Because there are multiple TAP nodes in the structure of the clock tree, in order to drive the multiple TAP nodes, the high-drive buffer, as a powerful drive unit, is used to drive a transmission path of the clock network behind the root node and the TAP nodes (buffers) at branch points of the clock tree and to satisfy the structural requirements of the H-clock tree.

In this embodiment, a clock network between the root node and the TAP nodes is taken as a trunk; a method for setting the non-default routing rule in S2 includes: a routing width and a number of metal layers are set for the trunk, and a shield mechanism is set in the trunk. A top layer and a second top layer of an application-specific process (AP) layer may be crossed to reduce the routing latency and clock crosstalk. Here, the shield mechanism is set for metal routing, and VSS ground wires may be configured on the two sides of the metal routing to shield interference from other signals; or, a shield coating, such as an electroconductive rubber coating, may be configured outside of the metal routing to fulfill an effective shielding effect.

It should be noted that in the design of the clock tree, the AP layer is a process layer for specific application or design. Here, the process layer refers to a specific metal or dielectric layer for constructing different circuit elements in integrated circuit fabrication. The selection and design of the AP layer are determined according to specific demands and desired performance of the clock tree. The clock tree, as a network structure for distributing clock signals in an integrated circuit, ensures that clock signals can be accurately and reliably transmitted to all modules or assemblies to be synchronized. When designing the clock tree, engineers should think carefully the transmission path, latency, power, reliability and other factors of clock signals, and the selection of the AP layer is crucial for fulfilling these purposes. The AP layer typically includes metal layers and dielectric layers, which are used for constructing the routing structure of the clock tree. The metal layers are used for transmitting clock signals, and the dielectric layers are used for isolating and protecting metal circuits. According to application requirements, the engineers can select metal and dielectric material with a suitable electrical conductivity, resistivity, and capacitively to optimize the clock signal transmission performance.

In this embodiment, in S2, a method for setting multiple TAP nodes includes: actual positions of macrocells on a board are determined according to a physical layer layout corresponding to the non-default routing rule and are eliminated from the clock network to avoid overlaps between the macrocells and the TAP nodes; then, multiple positions are selected in the clock network as positions of the TAP nodes, and the TAP nodes have a same path in the clock network. In actual design, the TAP nodes should be selected according to the layout and shape of the high-speed interface module and the position of each register used in the clock tree, and the same path of the TAP nodes in the clock network should be as short as possible to reduce the transmission latency, so as to reduce the skew generated during transmission of the clock signal and improve the stability of the clock signal.

S3, according to the setting in S1 and the setting in S2, an H-clock tree is created by means of the EDA tool, and H-clock tree synthesis is performed. Because of the special shape of the high-speed interface module, sinks are not uniformly mounted on corresponding TAP nodes, which will increase the skew of a clock tree. In view of this, multiple intermediate nodes are introduced between the root node and the TAP nodes in S2 to adapt to the high-speed interface module, and these intermediate nodes may be high-drive buffers or other buffers that can adapt to the high-speed interface module. Then, the clock network between the root node and the TAP nodes is edited in detail by means of an innovus script in the EDA tool, each redundant intermediate node between the root node and the TAP nodes is deleted, and only the high-drive buffer instantiated in S2 is reserved, such that the structure of the fishbone H-clock tree is simplified. Next, a plurality of sinks are mounted on each TAP node, a generated clock is defined for each TAP node by means of the EDA tool, and the TAP nodes are defined in a same source group. By defining the TAP nodes in the same source group, the consistency of the clock signal can be maintained. If the multiple TAP nodes are defined in different source groups, an inconsistency of the clock signal may be caused, thus affecting normal operation of a system. In addition, the definition of the TAP nodes in the same source group facilitates constraining and optimization of the clock tree, the design complexity of the clock tree is lowered, and the clock tree can be constrained and optimized more easily. Then, routing is performed according to the non-default routing role in S2 to complete construction of the fishbone H-clock tree.

It should be noted that the definition of a generated clock for each TAP node by means of the EDA tool means that each TAP node further transmits a received clock signal to subsequent other units rather than generating a new clock signal.

In this embodiment, the EDA tool includes a clock specification file, which defines specific parameters and attributes of the clock network, and with reference of the clock specification file, the EDA tool can create and optimize a clock. According to the clock specification file, a generated clock can be defined for each TAP node in S3, and numbers of sinks mounted on the TAP nodes can be uniformized. A seriously nonuniform distribution of sinks on the TAP nodes will lead to a great difference in the time of receiving a clock signal from the clock source by different sinks, thus compromising timing performance and leading to an instability of data; and it will also lead to different clock latencies of different TAP nodes, and some TAP nodes in a serious condition may even generate extreme clock latencies, thus seriously compromising the performance of the clock tree. Therefore, sinks are uniformly mounted on the TAP nodes to optimize the clock skew and improve the reliability and performance.

In this embodiment, the method further includes: after the fishbone H-clock tree is constructed, simulation verification is performed on the fishbone H-clock tree to verify clock latency and skew data; if a verification result is acceptable, all operations are ended; or, if the verification result is not acceptable, S1 is performed to repeat the operations until the verification result is acceptable. By setting the simulation verification mechanism, the performance of the fishbone H-clock tree can be further guaranteed.

In this embodiment, the method further includes: a monitoring module for monitoring the root node and each TAP node is configured in the fishbone H-clock tree, wherein the monitoring module is formed by nondeterministic digital memory cells. By monitoring the root node and each TAP node, when an error is detected, and the position of the error can be determined timely for modification. The nondeterministic digital memory cells are special memory cells, and the nondeterministic digital memory cells are used in the monitoring module to introduce some stochasticity or variability to provide more information and data during monitoring and analysis. In some application scenarios, the nondeterministic digital memory cells are used to generate stochastic monitoring data or carry out a fault injection test to evaluate the fault tolerance and robustness of the fishbone H-clock tree.

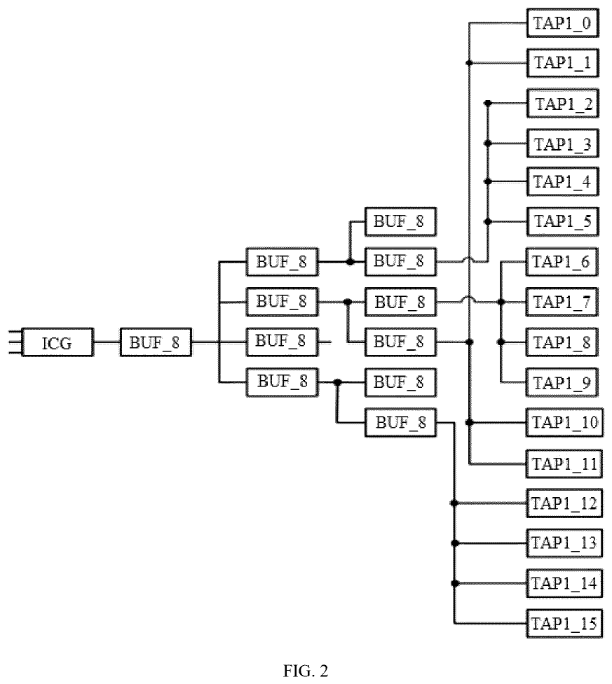

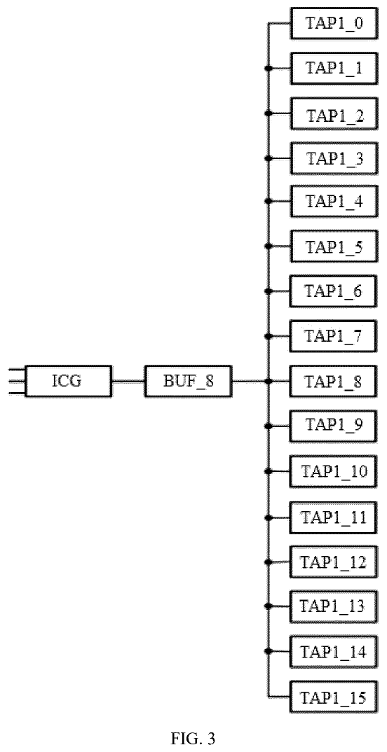

FIG. 2 is a connection diagram of high-drive buffers in the fishbone H-clock tree before redundant intermediate nodes are deleted, and FIG. 2 is a connection diagram of high-drive buffers in the fishbone H-clock tree after redundant intermediate nodes are deleted. With reference to FIGS. 2 and 3, a specific application example is provided below.

A clock tree is instantiated on a board formed by macrocells by means of an EDA tool, wherein the clock tree includes a clock source, a clock gating cell IGG, a high-drive buffer BUF_8 and 16 parallel TAP nodes, which are connected in sequence; the 16 TAP nodes are TAP1_0, TAP1_1, TAP1_2, . . . , TAP1_15 sequentially, and a plurality of sinks are mounted on each TAP node. The clock tree is initialized to eliminate existing definitions in the clock trees, and then the clock tree is reset.

The clock gating cell ICG in the clock tree is set to be in a cloneable state, an output terminal of the clock gating cell ICG is set as a root node of the clock tree, and a clock network between the root node and the TAP nodes is taken as a trunk of a fishbone H-clock tree. Then, a non-default routing rule is set, a routing width is set for the clock network, eleventh metal layers are set, the eleventh metal layer and the tenth metal layer are crossed, and each metal layer is coated with an electroconductive coating as a shield layer.

The actual positions of the macrocells on the board are determined, and these actual positions are eliminated from the clock network, such that overlaps between the marcrocells and the TAP nodes are avoided; then, new positions of the 16 TAP nodes are set according to the physical layout and shape of a high-speed interface module and the distribution positions of multiple registers in the clock tree, and the 16 TAPs has a shortest same path in the clock network.

Next, after the resetting is completed, an H-clock tree is created by means of the EDA tool, and H-clock tree synthesis is performed. Because of the special shape of the strip-shaped high-speed interface module, sinks at the tail end of the H-clock tree are not uniformly mounted on the TAP nodes, so 10 extra high-drive buffers BUF_8 are configured between the root node and the 16 TAP nodes as intermediate nodes to adapt to the high-speed interface module; and in the intermediate nodes, four high-drive buffers BUF_8 are connected in parallel with the shortest path, and each of the four high-drive buffers BUF_8 is connected in parallel with two high-drive buffers BUF_8.

Then, a clock network between the root node and the 16 TAP nodes is edited by means of an innovus script in the EDA tool, each redundant intermediate node between the root node and the TAP nodes is deleted to obtain the structure of the fishbone H-clock tree shown in FIG. 3, and only the high-drive buffer BUF_8 on the shortest path is reserved; sinks are mounted on each TAP node, a generated clock of each TAP node is defined by means of a clock specification file in the EDA tool, the TAP nodes are defined in a same source group, and the sinks are mounted the TAP nodes more uniformly. Specific data of sinks mounted on the PAT nodes are shown in Table 1:

TABLE 1
Distribution statistics of sinks mounted on different
TAP nodes of the fishbone H-clock tree

| | Number of sinks | Number of sinks |
|---|---|---|
| TAP nodes | in initial state | after redefinition |
| TAP1_0 | 231836 | 4504 |
| TAP1_1 | 18 | 11215 |
| TAP1_2 | 27 | 20644 |
| TAP1_3 | 15 | 16768 |
| TAP1_4 | 9 | 10059 |
| TAP1_5 | 21 | 23472 |
| TAP1_6 | 4 | 16795 |
| TAP1_7 | 25 | 14856 |
| TAP1_8 | 30 | 12181 |
| TAP1_9 | 6 | 798 |
| TAP1_10 | 10 | 11905 |
| TAP1_11 | 19 | 22619 |
| TAP1_12 | 32 | 11650 |
| TAP1_13 | 40 | 21178 |
| TAP1_14 | 33 | 17472 |
| TAP1_15 | 18 | 16036 |
| Total | 232152 | 232152 |

It can be known from Table 1 that as compared with the initial state, sinks are more uniformly mounted on the 16 TAP nodes after redefinition, under the condition that the total number of the sinks is not changed.

Further, actual routing and simulation verification of the fishbone H-clock tree are performed according to the setting of the H-clock tree to verify clock latency and skew data. Related data of the fishbone H-clock tree are compared with related data of a traditional clock tree by means of a control variable method, and specific clock latency and skew data are compared as shown in Table 2:

TABLE 2
Comparation of clock latency/skew of traditional clock tree and fishbone H-clock tree

| | | | | | | Standard | |
|---|---|---|---|---|---|---|---|
| | | | Minimum | Maximum | Average | deviation | |
| | Timing Comer | Slew group | latency | latency | latency | of latency | Skew |
| Traditional | wcl.setup.eaily | Core_clk/fiinc | 1.169 | 1.331 | 1.260 | 0.012 | 0.162 |
| clock tree | | | | | | | |
| Fishbone | wcl.setiip.early | Core_clk/fimc | 0.426 | 0.489 | 0.462 | 0.010 | 0.063 |
| H-clock | | | | | | | |
| tree | | | | | | | |

The unit of data in Table 2 is ps, and the two clock trees in the EDA tool adopt the same Timing Corner (the same timing process corner), which is specifically a wcl.setup.early process corner, including the combinations of process, voltage and temperature; the slew groups of the two clock trees are both set as Core_clk/func to ensure that the clock signals from the clock source are the same, and the slew groups are used to balance the clock signals to control the clock signals to rise or fall in the transmission process. Obviously, under the condition that variables are controlled, the clock latency of the fishbone H-clock tree is much smaller than the clock latency of the traditional clock tree, the clock skew of the clock signal is also smaller, and the standard deviation of the latency is improved to some extent, indicating that the stability and effectiveness are better. Upon verification, the clock delay and skew of the fishbone H-clock tree are actually acceptable, and all operations are ended.

According to the invention, intermediate nodes are introduced into the clock network and then redundant nodes are eliminated, such that the H-clock tree is compatible with a high-speed interface module, and the clock latency and skew are effectively reduced to facilitate timing recovery; in addition, sinks are uniformly mounted on the TAP nodes, such that the performance is improved, and loads are balanced; in addition, metal routing is optimized, and the shield mechanism is set, such that the performance of the H-clock tree is effectively improved.

The above embodiments are merely used for explaining the technical concept of the invention and are not intended to limit the protection scope of the invention. Any modifications made based on the technical concept of the invention should also fall within the protection scope of the invention.

What is claimed is:

1. A method for constructing a fishbone H-clock tree suitable for a high-speed interface module, comprising the following steps:
S1, setting an instance of a clock tree by an electronic design automation (EDA) tool, instantiating a clock gating cell in advance, and eliminating existing definitions in the clock tree;
S2, taking an output terminal of the clock gating cell in S1 as an initial position of a root node, and setting a non-default routing rule and a plurality of test access port (TAP) nodes in the clock tree; and
S3, according to the setting in S1 and the setting in S2, creating an H-clock tree and performing clock tree synthesis by the EDA tool, wherein the clock tree synthesis at least comprises:
introducing a plurality of intermediate nodes between the root node and the TAP nodes in S2 to adapt to a high-speed interface node; editing a clock network between the root node and the TAP nodes by an innovus script in the EDA tool, and deleting each redundant intermediate node between the root node and the TAP nodes to obtain a structure of a fishbone H-clock tree; mounting a plurality of sinks on each TAP node, defining a generated clock for each TAP node by the EDA tool and defining the TAP nodes in a same source group; and performing routing according to the non-default routing rule in S2 to complete construction of the fishbone H-clock tree.

2. The method according to claim 1, wherein when the clock gating cell is set in S1, the clock gating cell is set to be in a cloneable state.

3. The method according to claim 1, wherein the clock network between the root node and the TAP nodes is taken as a trunk; and in S2, a method for setting the non-default routing rule comprises: setting a routing width and a number of metal layers for the trunk, and setting a shield mechanism in the truck.

4. The method according to claim 3, wherein after the number of metal layers is set for the truck, a top metal layer and a second top metal layer are crossed.

5. The method according to claim 1, wherein in S2, a method for setting the plurality of TAP nodes comprises: eliminating overlapped nodes from the clock network according to a physical layer layout corresponding to the non-default wiring rule; and after the overlapped nodes are eliminated from the clock network, selecting a plurality of positions in the clock network as positions of the TAP nodes, and the TAP nodes have a same path in the clock network.

6. The method according to claim 1, wherein the EDA tool comprises a clock specification file, wherein the generated clock is defined for each TAP in S3 according to the clock specification file, and numbers of sinks mounted on the TAP nodes are uniformized.

7. The method according to claim 1, further comprising: after the construction of the fishbone H-clock tree is completed, performing simulation verification on the fishbone H-clock tree; when a verification result is acceptable, ending all operations; or, when the verification result is not acceptable, returning to S1 to repeat the operations until the verification result is acceptable.

8. The method according to claim 1, further comprising: configuring, in the fishbone H-clock tree, a monitoring module for monitoring the root node and each TAP node, wherein the monitoring module is formed by nondeterministic digital memory cells.
